(19) United States
(12) Patent Application Publication
(10) Pub. No.: US 2015/0165681 A1
(43) Pub. Date: Jun. 18, 2015

(54) REAL-TIME PROCESS CONTROL FOR ADDITIVE MANUFACTURING

(71) Applicant: Board of Regents, The University of Texas System, Austin, TX (US)

(72) Inventors: Scott Fish, Austin, TX (US); Joseph Beaman, Austin, TX (US); Adam Bryant, Austin, TX (US); David Leigh, Belton, TX (US); Steven Kubiak, Austin, TX (US); John Cameron Booth, Austin, TX (US)

(21) Appl. No.: 14/575,484

(22) Filed: Dec. 18, 2014

Related U.S. Application Data
(60) Provisional application No. 61/917,652, filed on Dec. 18, 2013.

(51) Int. Cl. B29C 67/00; B29C 35/08

(52) U.S. Cl. CPC B29C 67/0077; B29C 35/0866; B33Y 30/00

(57) ABSTRACT

An example apparatus for producing a part from a powder using a powder sintering process can include a build chamber including one or more walls and a build piston configured to support the powder and the part. Additionally, the build chamber can enclose a build cylinder and a build surface, and the build piston can be arranged at least partially within the build cylinder. The apparatus can also include a plurality of heat sources distributed in the walls of the build chamber, the build cylinder and/or the build piston, an energy source arranged outside of the build chamber and configured to produce and direct an energy beam to the build surface, and a controller configured to control the heat sources.

### CROSS-REFERENCE TO RELATED APPLICATION

This application claims priority to and benefit of U.S. Provisional Patent Application Ser. No. 61/917,652 filed on Dec. 18, 2013, which is fully incorporated by reference and made a part hereof.

### BACKGROUND

Selective laser sintering (“SLS”) is an additive manufacturing technology. SLS is used to manufacture a three-dimensional component (e.g., a part) in a layer-by-layer fashion from a powder such as plastic, metal, polymer, ceramic, composite materials, etc. For example, successive layers of powder are dispensed onto a target surface (e.g., a build surface) and a directed energy beam is scanned over the build surface to sinter each layer of powder to a previously sintered layer of powder. The directed energy beam is typically a laser, which can be modulated and precisely directionally controlled. The scan pattern of the directed energy beam is controlled using a representation such as a computer-aided design (“CAD”) drawing, for example, of the part to be built. In this way, the directed energy beam is scanned and modulated such that it melts portions of the powder within the boundaries of a cross-section of the part to be formed for each layer. For example, SLS is described in detail in U.S. Pat. No. 5,053,090 to Beaman et al. and U.S. Pat. No. 4,938,816 to Beaman et al.

### SUMMARY

Described herein are devices and methods for providing real-time control of powder sintering processes, which reduce or eliminate defects and internal stresses in components (e.g., parts) produced during the buildup and cooling phases of the powder sintering processes.

An example apparatus for producing a part from a powder using a powder sintering process can include a build chamber including one or more walls and a build piston configured to support the powder and the part. Additionally, the build chamber can enclose a build cylinder and a build surface, and the build piston can be arranged at least partially within the build cylinder. The apparatus can also include a plurality of heat sources distributed in the walls of the build chamber, the build cylinder and/or the build piston, an energy source arranged outside of the build chamber and configured to produce and direct an energy beam to the build surface, and a controller configured to control the heat sources. For example, the controller can control the heat sources to maintain an approximately uniform temperature distribution within the build chamber during the powder sintering process. This disclosure contemplates selectively and individually controlling each of the heat sources. Alternatively or additionally, a size and/or a shape of the build chamber and the arrangement of the heat sources can minimize flow over the build surface.

Additionally, the build cylinder and/or the build piston can include one or more inlet or outlet ports formed therein for accommodating a flow of build chamber gases. Optionally, an inlet port can be a gas inlet port for supplying gas to the build chamber. Optionally, an outlet port can be a gas outlet port for exhausting gas from the build chamber. In addition, the controller can be further configured to control operation of the inlet or outlet ports to adjust a temperature and/or a chemical composition of the build chamber gases, for example, by facilitating supply and/or exhaust of gas to/from the build chamber. This disclosure contemplates selectively and individually controlling each of the inlet or outlet ports.

Alternatively or additionally, the controller can be further configured to control the heat sources and/or the inlet or outlet ports to maintain the part at variable temperatures during the powder sintering process. For example, the variable temperatures can be optimized for powder sintering and annealing of induced internal stresses in the part.

Additionally, the apparatus can optionally include a multi-spectral imaging device configured to acquire images of the build surface, the powder, the part, the walls of the build chamber and/or the build cylinder. The controller can be further configured to receive the images acquired by the multi-spectral imaging device, estimate respective temperature distributions of the build surface, the powder, the part, the walls of the build chamber and/or the build cylinder from the images acquired by the multi-spectral imaging device, and control the energy source (e.g., the operating characteristics and/or scan pattern of the energy beam), the heat sources and/or the inlet or outlet ports based on the estimated respective temperature distributions. For example, the multi-spectral imaging device can be an infrared imaging device. Optionally, the controller can be further configured to calculate a theoretical or computational model for respective temperature distributions for the build surface, the powder, the part, the walls of the build chamber and/or the build cylinder under similar build chamber conditions, compare the estimated respective temperature distributions with the theoretical or computational model, and control the energy source, the heat sources and/or the inlet or outlet ports based on the comparison.

Alternatively or additionally, the apparatus can optionally include a non-optical imaging device configured to acquire images of the powder and the part. The controller can be further configured to receive the images acquired by the non-optical imaging device, determine a condition of the part from the images acquired by the non-optical imaging device, and control the energy source, the heat sources and/or the inlet or outlet ports based on based on the condition of the part. For example, the non-optical imaging device can be an acoustic or electro-magnetic imaging device.

Alternatively or additionally, the apparatus can optionally include a bore-sighted multi-spectral imaging device configured to acquire images of an energy beam-powder interaction region on the build surface. As used herein, the energy beam-powder interaction region includes a point where the energy beam intersects the build surface and can optionally include a melt pool (e.g., at least a portion of the melted powder). The controller can be further configured to receive the images acquired by the bore-sighted multi-spectral imaging device and estimate real-time properties of the energy beam-powder interaction region from the images acquired by the bore-sighted multi-spectral imaging device. The controller can also be configured to calculate a theoretical or computational model for an energy beam-powder interaction region for a similar powder material under similar build chamber conditions, compare the estimated real-time properties of the energy beam-powder interaction region with the theoretical or computational models, and control the energy source, the heat sources and/or the inlet or outlet ports based on the comparison.

Optionally, the apparatus can include an energy beam power meter configured to measure a power of the energy beam, where the energy beam power meter is arranged near the build surface within the build chamber. The controller can be further configured to receive the power of the energy beam, and control the energy source based on the power of the energy beam measured within the build chamber.

Additionally, the apparatus can include a powder feed device arranged outside of the build chamber. The powder feed device can include a powder feed bin configured to store the powder, a powder metering device configured to dispense a measured amount of the powder from the powder feed bin, and a powder drop chute configured to guide the measured amount of the powder into the build chamber. The powder metering device can be arranged between the powder feed bin and the powder drop chute. Optionally, the powder metering device and the powder drop chute are configured to scatter the measured amount of the powder such that the measured amount of the powder undergoes rapid heat transfer as the powder enters the build chamber. For example, the powder can rapidly increase in temperature from an approximate temperature of the powder feed bin to a temperature that minimizes thermal mismatch and part curl when the powder is spread over the build surface. Optionally, the powder drop chute can be configured to deliver the measured amount of the powder to a position near the build surface within the build chamber. In addition, the apparatus can include a strip heater arranged in the build chamber at the position near the build surface.

Alternatively or additionally, the apparatus can include a powder spreading device including a powder spreading roller, a drive system and a thermal box. The powder spreading roller can be arranged within the build chamber, and the drive system and thermal box can be arranged outside of the build chamber. In addition, the drive system can be configured to control at least one of translation and rotation of the powder spreading roller. Further, the thermal box can include one or more thermal seals between the build chamber and components of the drive system. Optionally, the drive system can include a translation drive system configured to control the translation of the powder spreading roller, and a rotation drive system configured to control the rotation of the powder spreading roller.

Optionally, the powder sintering process includes building of the part and subsequent cooling down of the part.

An example method for real-time control of a powder sintering process for producing a part from a powder can include providing a build chamber that encloses a build surface, and acquiring, using a multi-spectral imaging device, images of the build surface, the build chamber, the part and/or the powder. In addition, the method can include, using a controller, estimating respective temperature distributions of the build surface, the build chamber, the part and/or the powder from the images acquired by the multi-spectral imaging device, and controlling the powder sintering process based on the estimated respective temperature distributions. Optionally, the method can further include, using the controller, calculating a theoretical or computational model for respective temperature distributions for the build surface, the build chamber, the part and/or the powder under similar build chamber conditions, comparing the estimated respective temperature distributions with the theoretical or computational model, and controlling the energy source, the heat sources and/or the inlet or outlet ports based on the comparison.

Alternatively or additionally, the method can include acquiring, using a non-optical imaging device, images of the part and the powder. The method can further include, using the controller, determining a condition of the part from the images acquired by the non-optical imaging device, and controlling the powder sintering process based on the condition of the part.

Additionally, the method can include providing an energy source configured to produce and direct an energy beam to the build surface. In addition, the step of controlling the powder sintering process can include adjusting characteristics of the energy beam (e.g., the operating characteristics and/or scan pattern of the energy beam). Alternatively or additionally, the method can include acquiring, using a bore-sighted multi-spectral imaging device, images of an energy beam-powder interaction region on the build surface, e.g., a point where the energy beam intersects the build surface and can optionally include a melt pool. The method can further include, using the controller, estimating real-time properties of the energy beam-powder interaction region from the images acquired by the bore-sighted multi-spectral imaging device, calculating a theoretical or computational model for an energy beam-powder interaction region for a similar powder material under similar build chamber conditions, comparing the estimated real-time properties of the energy beam-powder interaction region with the theoretical or computational model, and controlling the powder sintering process based on the comparison.

Additionally, the build chamber can include a plurality of heat sources distributed therein. Further, the step of controlling the powder sintering process can include energizing or de-energizing one or more of the heat sources. This disclosure contemplates selectively and individually controlling each of the heat sources. For example, the heat sources can be controlled to maintain an approximately equal temperature distribution within the build chamber.

Alternatively or additionally, the build chamber can enclose a build cylinder having a build piston arranged at least partially therein, and the build piston can be configured to support the powder and the part. Further, the build cylinder and/or the build piston can have one or more inlet or outlet ports formed therein. The step of controlling the powder sintering process can include controlling operation of the inlet or outlet ports to adjust at least one of a temperature or a chemical composition of build chamber gases. This disclosure contemplates selectively and individually controlling each of the inlet or outlet ports.

Optionally, the step of controlling the powder sintering process can include maintaining the part at variable temperatures during the powder sintering process. For example, the variable temperatures can be optimized for powder sintering and annealing of induced internal stresses in the part.

Additionally, the method can include providing a powder feed bin configured to store powder, where the powder feed bin is arranged outside of the build chamber, and dispensing a measured amount of the powder from the powder feed bin into the build chamber. In addition, the measured amount of the powder can undergo rapid heat transfer as the powder enters the build chamber between an approximate temperature of the powder feed bin and a temperature that minimizes thermal mismatch and part curl when the powder is spread over the build surface.

Alternatively or additionally, the method can include providing a powder spreading device including a powder spreading roller and a drive system configured to control translation and rotation of the powder spreading roller. The powder spreading roller can be arranged within the build chamber, and the drive system can be arranged outside of the build chamber. A thermal box including one or more thermal seals between the build chamber and components of the drive system can also be provided. The method can further include independently controlling, using the drive system, the translation and the rotation of the powder spreading roller.

Another example method for real-time control of a powder sintering process for producing a part from a powder can include providing a build chamber that encloses a build surface, and acquiring, using a multi-spectral imaging device, images of the build surface, the build chamber, the part and/or the powder. The method can also include, using a controller, estimating respective real-time temperature distributions of the build surface, the build chamber, the part and/or the powder from the images acquired by the multi-spectral imaging device, calculating a real-time physics-based model of the powder sintering process based on the respective real-time temperature distributions, and controlling the estimated powder sintering process based on the real-time physics-based model.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a diagram illustrating an apparatus for producing a part from a powder using a powder sintering process;

FIG. 2 is a diagram illustrating heat sources of the apparatus shown in FIG. 1;

FIG. 3 is a diagram illustrating inlet or outlet ports of the apparatus shown in FIG. 1;

FIG. 4 is a diagram illustrating a powder feed device of the apparatus shown in FIG. 1;

FIG. 5 is a diagram illustrating a powder spreading device of the apparatus shown in FIG. 1;

FIG. 6 is a diagram illustrating a bore-sighted multi-spectral imaging device of the apparatus shown in FIG. 1; and

FIG. 7 is a block diagram of an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. While implementations will be described for providing real-time control of SLS processes, it will become evident to those skilled in the art that the implementations are not limited thereto, but are applicable for providing real-time control of other powder sintering processes.

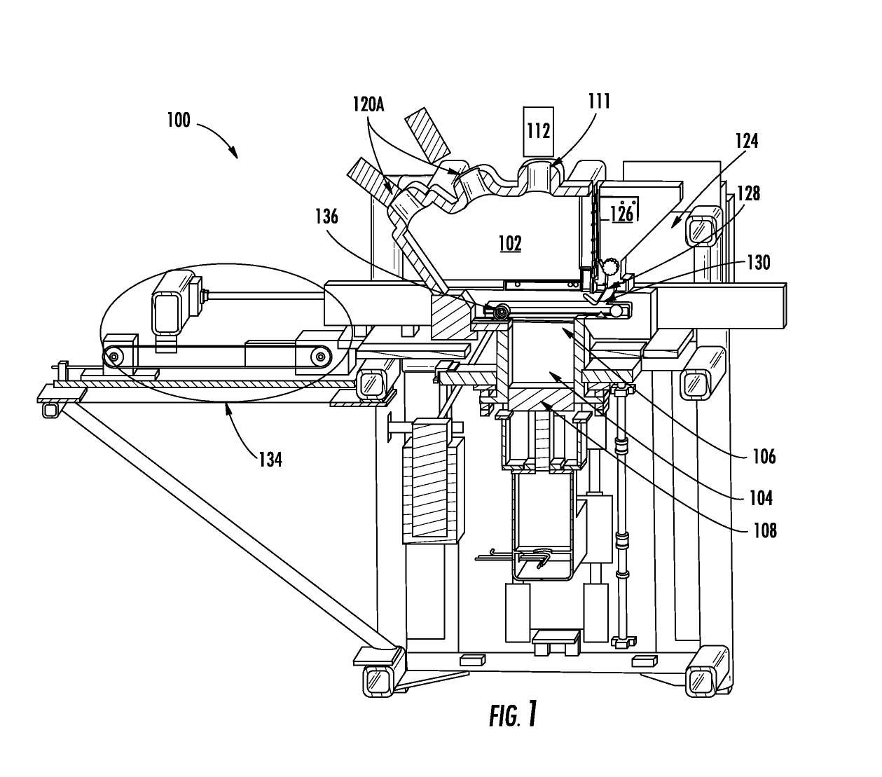

Referring now to FIG. 1, a diagram illustrating an apparatus 100 for producing a part from a powder using a powder sintering process is shown. An example powder sintering process is SLS, which is used to manufacture a three-dimensional component in a layer-by-layer fashion from a powder, as described above. As used herein, the powder sintering process can include both the part build-up process and the part cool-down process. This disclosure contemplates that the powder can be a material including, but not limited to, plastics, metals, polymers, ceramics and composite materials. The apparatus 100 can include a build chamber 102. The build chamber 102 is the portion of the apparatus 100 in which the part is formed through the powder sintering process. In addition, the build chamber 102 can include one or more walls and can enclose a build cylinder 104 and a build surface 106. The build cylinder 104 is the portion of the build chamber 102 that contains the powder and part (e.g., the part cake) during the powder sintering process. As used herein, the part and powder can be referred to as the part cake, e.g., the mass of powder in which the part is formed. The build surface 106 is at the top of the build cylinder 104, for example, a region where the powder is spread before sintering. The apparatus 100 can also include a build piston 108, which is configured to support the powder and part (e.g., the part cake) during the powder sintering process. In other words, the part cake is supported on the build piston 108. As shown in FIG. 1, the build piston 108 is arranged at least partially within the build cylinder 104. As described above, the part is formed in a layer-by-layer fashion, for example, by depositing and sintering successive layers of powder. The build piston 108 can therefore be configured to incrementally move downward within the build cylinder 104 after sintering each layer of powder, thus, permitting the next layer of powder to be deposited and spread over the build surface 106 before sintering.

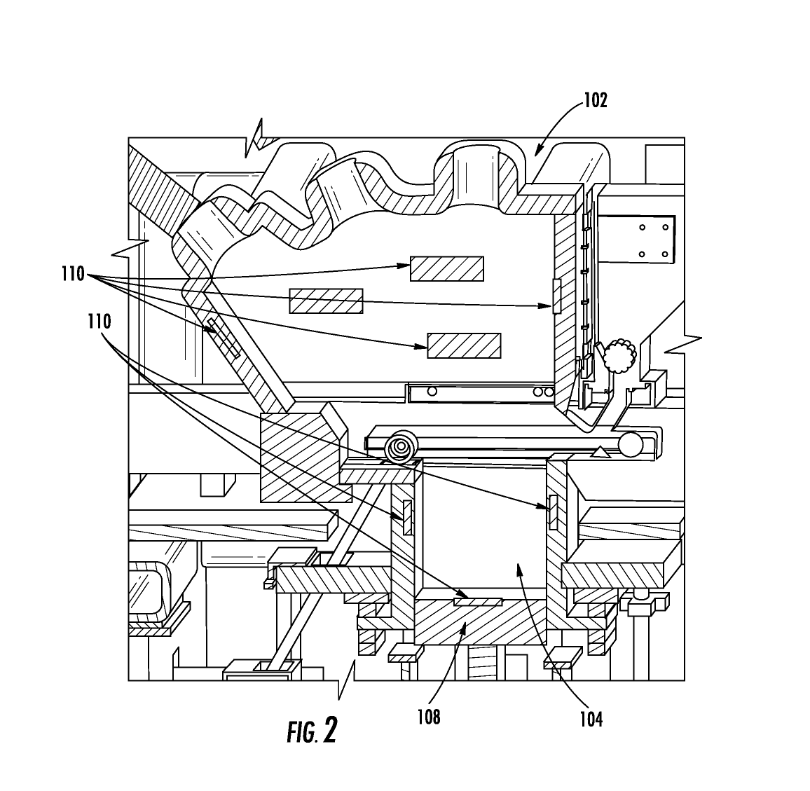

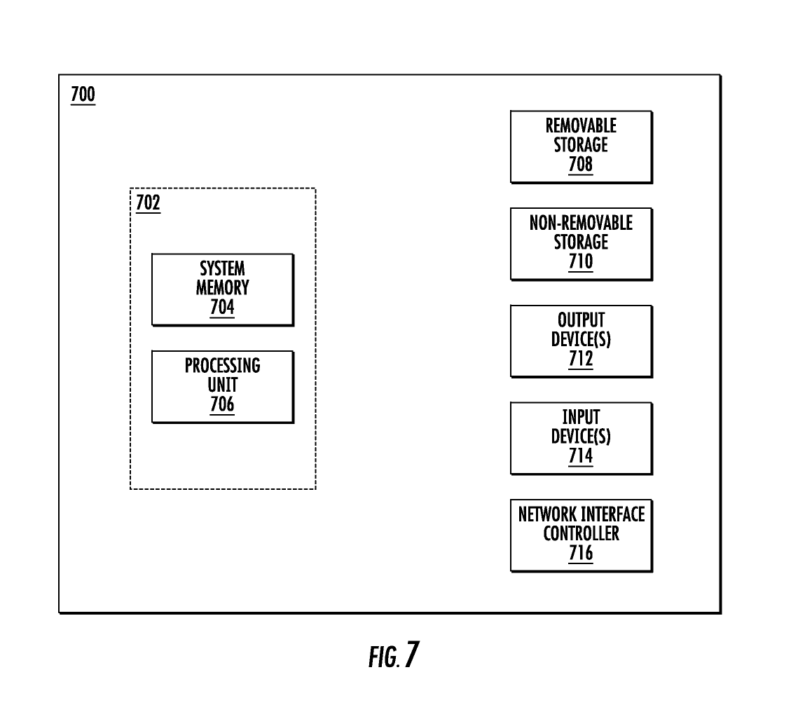

A plurality of heat sources can be distributed throughout the build chamber 102. For example, heat sources can be distributed in the walls of the build chamber, the build cylinder and/or the build piston. For example, as shown in FIG. 2, heat sources 110 are provided in the walls of the build chamber 102, the build cylinder 104 and the build piston 108. Additionally, a size and/or a shape of the build chamber 102 and/or the arrangement of the heat sources 110 can minimize flow over the build surface 106. It should be understood that the size and shape of the build chamber 102, as well as the number and arrangement of the heat sources 110, shown in FIG. 2 are provided only as an example. Therefore, this disclosure contemplates that one skilled in the art could design a build chamber having different sizes and shapes and/or numbers and arrangements of heat sources according to this disclosure. The heat sources 110 can be selectively, and optionally individually, controlled to maintain an approximately uniform temperature distribution within the build chamber 102 during the powder sintering process. For example, a controller (e.g., the controller described with regard to FIG. 7) can be used to send a signal to energize/de-energize each of the heat sources. By maintaining uniform temperature distribution within the build chamber 102, it is possible to minimize or eliminate temperature variations over the build surface 106, which minimizes or eliminates natural thermal convention patterns (which are sometimes turbulent) induced by temperature variations. The natural thermal convention patterns induced by temperature variations in conventional build chambers result in non-uniform heat transfer, which can result in pre-mature part failure, for example, caused by internal stresses during the manufacturing process.

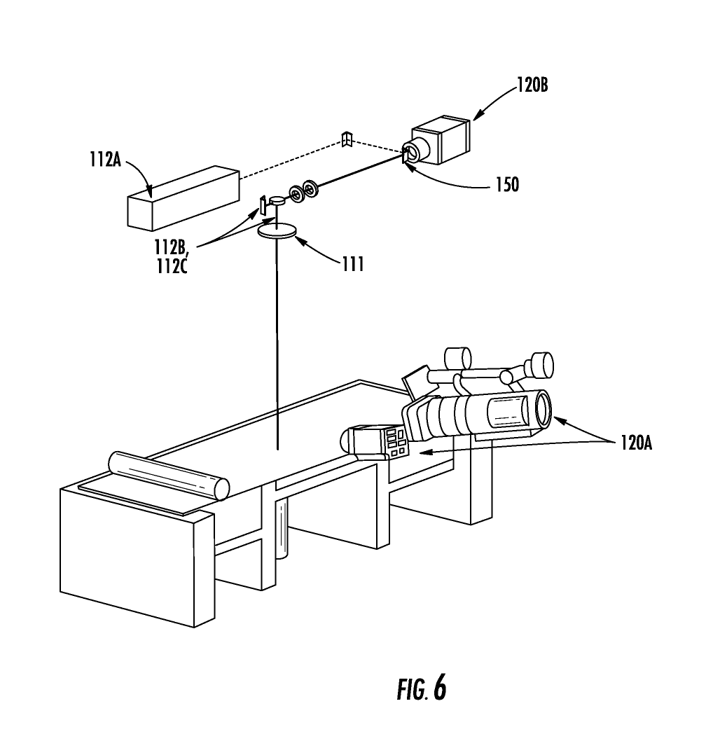

The apparatus 100 can also include an energy source 112. As shown in FIG. 1, the energy source 112 can be arranged outside of the build chamber 112. An example energy source is also shown in FIG. 6. The energy source 112 can be configured to produce and direct an energy beam through a window (e.g., window 111 shown in FIG. 6) in the build chamber 102 to the build surface 106. For example, the energy source 112 can include a laser (e.g., laser 112A shown in FIG. 6). The type of laser can be selected, for example, based on the type of powder to be sintered. Lasers are well-known in the art and are therefore not described in further detail. Although a laser is used as an example, this disclosure contemplates using other types of energy beams to sinter the powder. Additionally, a system of lenses, prisms, mirrors, etc. can be used to focus and control the scanning pattern of energy beam (e.g., the laser). As described above, the energy beam can be scanned over the build surface 106 in order to melt portions of powder within the boundaries of a cross-section of the part to be formed. A controller (e.g., the controller described with regard to FIG. 7) can be configured to use a CAD drawing, for example, to determine the boundaries of the cross-section of the part to be formed for each successive layer of powder deposited and spread over the build surface 106. The controller can also be configured to modulate (e.g., turn ON/OFF) the laser when the energy beam is directed within/outside the cross-section of the part to be formed. Further, the controller can be configured to drive steering mirrors (e.g., mirrors 112B, 112C shown in FIG. 6), for example, to scan the energy beam over the build surface 106. For example, the controller can be configured to send a signal that drives a first galvonometer to precisely position a first mirror (e.g., mirror 112B shown in FIG. 6) to scan the energy beam in the x-direction, and the controller can be configured to send a signal that drives a second galvonometer to precisely position a second mirror (e.g., mirror 112C shown in FIG. 6) to scan the energy beam in the y-direction. The first and second mirrors can be mounted at right angles to one another, and the energy beam can be directed from the first and second mirrors through the window (e.g., window 111 shown in FIG. 6) into the build chamber 102. It should be understood that energy beam control and scanning systems are also well known in the art and that the components illustrated in FIG. 6 are provided only as an example. Thus, this disclosure contemplates that one skilled in the art could design an energy source having more or less components than shown in FIG. 6.

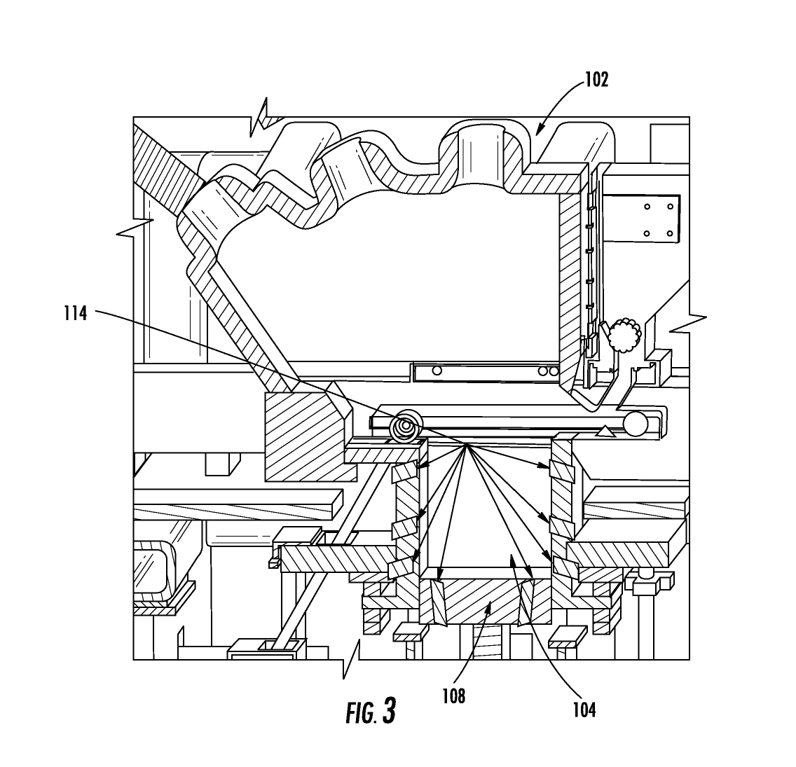

The build cylinder 104 and/or the build piston 108 can include one or more inlet or outlet ports formed therein for accommodating a flow of build chamber gases. Optionally, an inlet port can be a gas inlet port for supplying gas to the build chamber 102. Optionally, an outlet port can be a gas outlet port for exhausting gas from the build chamber 102. FIG. 3 illustrates a plurality of inlet or outlet ports 114 formed in the build cylinder 104 and the build piston 108 of the build chamber 102. It should be understood that the inlet and outlet ports 114 shown in FIG. 3 are provided only as an example and that other numbers and/or arrangements of the ports can be used. In addition, a controller (e.g., the controller described with regard to FIG. 7) can be configured to control operation of the inlet or outlet ports, for example by sending a signal to open/close the inlet or outlet ports, to adjust a temperature and/or a chemical composition of the build chamber gases. In other words, the controller can selectively, and optionally individually, open/close each of the inlet or outlet ports. This disclosure contemplates using variable (or multiple) atmospheric conditions during the powder sintering process, which includes both the product build up and subsequent cool down. The atmospheric conditions can be optimized for heat transfer and/or chemical action control during different phases of the powder sintering process. Thus, by opening/closing the inlet or outlet ports, it is possible to supply certain gases (e.g., O₂, N₂, air, or other gas at desired temperatures) and/or exhaust of gases to/from the build chamber 102 to achieve the desired atmospheric conditions during the powder sintering process. Alternatively or additionally, the inlet or outlet ports can be controlled to supply/exhaust gases to maintain the part being built at variable temperatures during the powder sintering process. For example, the variable temperatures can be optimized for powder sintering and annealing of induced internal stresses in the part. For example, a hot gas can optionally be supplied through one or more of the inlet ports in the build cylinder 104 or the build piston 108 in order to heat/maintain the part cake (e.g., the part and powder) at an elevated temperature as compared to the temperature of the build chamber to achieve a stress relief anneal.

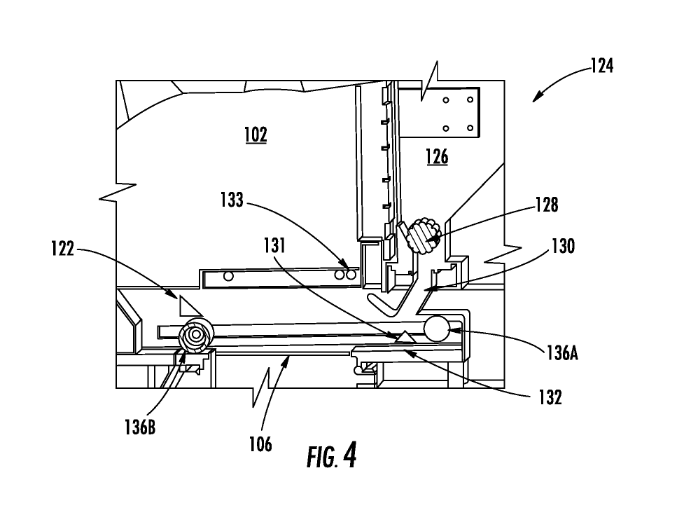

The apparatus 100 can also include a powder feed device 124 arranged outside of the build chamber 102. The powder feed device 124 is also shown in FIG. 4. The powder feed device 124 can include a powder feed bin 126, a powder metering device 128 and a powder drop chute 130. As shown in FIGS. 1 and 4, the powder metering device 128 can be arranged between the powder feed bin 126 and the powder drop chute 130. The powder feed bin 126 is configured to store the powder, for example, at a temperature at which the powder is not degraded. The powder metering device 128 is configured to dispense a measured amount of the powder from the powder feed bin 126. For example, the powder metering device 128 can optionally be a rotating cylinder with longitudinal slots. The slots can hold a desired amount of the powder (e.g., the measured amount of the powder). When the cylinder rotates, the measured amount of the powder is dropped into the powder drop chute 130, which is configured to guide the measured amount of the powder into the build chamber 102. The powder drop chute 130 can be configured to deliver the measured amount of the powder to a position 131 near the build surface 106 within the build chamber 102. As described below, the measured amount of the powder can be dropped in a position where a powder spreading device can spread the powder over the build surface 106. As shown in FIG. 4, the position 131 can be slightly spaced apart from the build surface 106. Optionally, a strip heater 132 can be arranged in the build chamber 102 at the position 131 near the build surface 106. Alternatively or additionally, a lamp heater 133 can be arranged in the build chamber 102 in proximity to the position 131 near the build surface 106. The strip heater 132 and/or the lamp heater 133 can be energized/de-energized, for example with a controller (e.g., the controller described with regard to FIG. 7), to heat the measured amount of powder to the desired temperature before spreading it over the build surface 106.

The powder metering device 128 and the powder drop chute 130 can be configured to scatter the measured amount of the powder such that the measured amount of the powder undergoes rapid heat transfer as the powder enters the build chamber 102. As described above, the powder is stored in the powder feed bin 126, for example, at a temperature below which the powder does not degrade. Upon entering the build chamber 102, the measured amount of powder can undergo rapid heat transfer (e.g., flash) to a higher temperature. For example, the powder can rapidly increase in temperature from the approximate temperature of the powder feed bin to a temperature that minimizes thermal mismatch between the powder and the build surface 106 when the powder is spread. This minimizes the amount of heat transfer between each successive layer of powder spread over the existing part cake, which minimizes thermal stresses and associated part curl. In contrast, when there is thermal mismatch between the powder and the existing part cake, temperature gradients can induce thermal stresses that might damage the part being built. Optionally, as described above, the strip heater 132 and/or the lamp heater 133 can also be used to heat the powder to the desired temperature before spreading the powder over the build surface 106.

The apparatus 100 can also include an energy beam power meter (e.g., the laser power meter 122 shown in FIG. 4) configured to measure a power of the energy beam. The energy beam power meter can be arranged near the build surface 106 within the build chamber 102. Thus, it is possible to conduct in-situ beam calibration (e.g., adjust characteristics of the energy beam such as energy beam power) during the build process based on the actual energy beam characteristics (e.g., power) inside the build chamber 102 at or near the point where the energy beam impacts the build surface 106. For example, a controller (e.g., the controller described with regard to FIG. 7) can be configured to receive the power of the energy beam detected by the energy beam power meter, and control the energy source based on the power of the energy beam measured within the build chamber 102. In a build chamber, the window through which the energy beam passes can become contaminated due to outgassing of the powder during heating/sintering. These contaminants can absorb or divert power from the intended powder heating point with resulting variation in part properties through the depth of the part cake. Alternatively or additionally, the energy beam source can degrade over time. By measuring energy beam power in the build chamber 102, it is therefore possible to compensate for beam degradation over time either associated with conditions external to the build chamber 102 (e.g., energy beam source degradation) or internal to the build chamber 102 (e.g., contamination of window through which the energy beam passes).

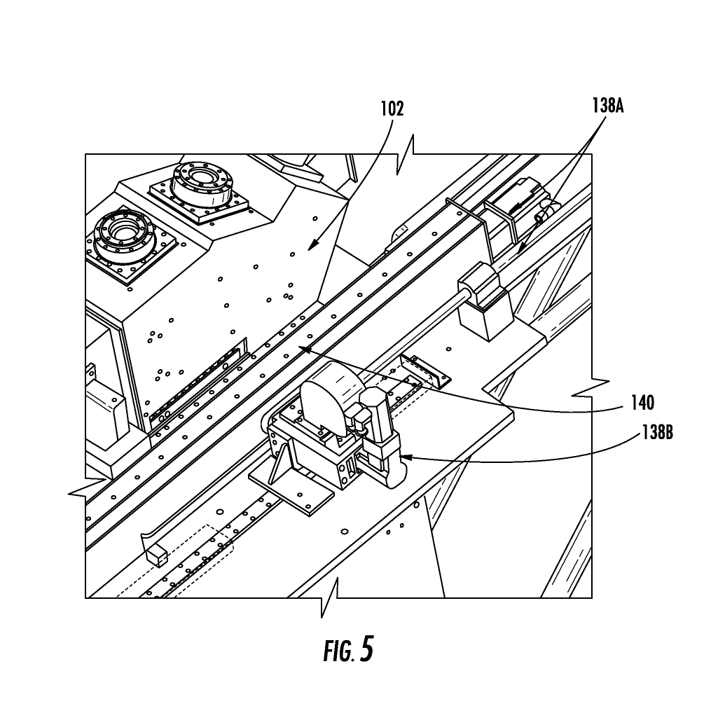

The apparatus 100 can also include a powder spreading device 134. The powder spreading device 134 can be configured to enable fine control the thickness of each successive layer of powder during the powder sintering process. The powder spreading device 134 is also shown in FIG. 5. The powder spreading device 134 can include a powder spreading roller 136, a drive system 138A and 138B (collectively referred to as 138) and a thermal box 140. The powder spreading roller 136 can be arranged within the build chamber 102, and the drive system 138 and thermal box 140 can be arranged outside of the build chamber 102. The thermal box 140 can provide thermal isolation between the build chamber 102 and the drive system 138. For example, the thermal box 140 can include one or more thermal seals between the build chamber 102 and components (e.g., bearings, seals, actuators, etc.) of the drive system 138, which prevents the components of the drive system 138 being exposed to high ambient temperatures of the build chamber 102 (e.g., greater than 350 degrees Celsius). In addition, the drive system 138 can be configured to independently control translation and rotation of the powder spreading roller. Optionally, the drive system can include a translation drive system 138A configured to independently control the translation of the powder spreading roller 136, e.g., as shown in FIG. 4, translation between the position of the powder spreading roller 136A before spreading the measured amount of the powder (e.g., the powder dropped at the position 131 near the build surface 106) over the build surface 106 and the position of the powder spreading roller 136B after spreading the measured amount of the powder over the build surface 106. The drive system can also include a rotation drive system 138B configured to independently control the rotation of the powder spreading roller 136, e.g., a rotation counter (or opposite) to the direction of translation. By providing independent, multi-axis (e.g., rotation and translation) of the powder spreading roller 136, it is possible to enable flat and non-flat powder layer deposition, as well as variable compaction properties, over the build surface 106.

The apparatus 100 can optionally include a multi-spectral imaging device 120A configured to acquire images of the build surface 106, the powder, the part, the walls of the build chamber 102 and/or the build cylinder 104. Optionally, the multi-spectral imaging device 120A can be used to acquire images of at least two of the build surface 106, the powder, the part, the walls of the build chamber 102 and/or the build cylinder 104 (e.g., as opposed to acquiring only images of a single region such as the build surface 106, for example). As shown in FIG. 1, the multi-spectral imaging device 120A can be arranged outside the build chamber 102 and acquire images through windows in the build chamber 102. The multi-spectral imaging device 120A can optionally be an infrared (“IR”) imaging device. Although an IR imaging device is used in the example provided below, it should be understood that imaging devices that operate in other portions of the electromagnetic spectrum can be used. Then, using a controller (e.g., the controller described with regard to FIG. 7), respective temperature distributions of the build surface 106, the powder, the part, the walls of the build chamber 102 and/or the build cylinder 104 can be estimated from the images acquired by the multi-spectral imaging device 120A. This information can be used as feedback to provide real-time control the energy source (e.g., the energy source 112 shown in FIGS. 1 and 6), the heat sources (e.g., heat sources 110 shown in FIG. 2) and/or the inlet or outlet ports (e.g., inlet and outlet ports 114 shown in FIG. 3). For example, using the controller, it is possible to adjust characteristics (e.g., power, scan pattern, scan rate, etc.) of the energy beam. Alternatively or additionally, it is possible to energize/de-energize one or more of the heat sources. Alternatively or additionally, it is possible to open/close one or more of the inlet or outlet ports. As described above, by controlling the energy source, heat sources and/or inlet or outlet ports, it is possible to provide real-time control of the build chamber environment (e.g., temperature, temperature distribution, chemical composition, etc.) and/or the part cake conditions (e.g., temperature, temperature distribution, etc.) during the powder sintering process. This can provide the capability to adaptively control the thermal temperature time history with an increased level of detail, which can facilitate higher predictability and performance in the adaptive manufacturing process.

Optionally, physics and cyber-enabled manufacturing (“CeMs”) process controls can be implemented to control the powder sintering processes described herein. CeMs process controls use high-fidelity physics-based models, as well as real-time measurements, to control the powder sintering process. For example, the physics-based models can provide a theoretical or computational model(s) of the energy beam-powder interaction region, flow and distribution of thermal energy in the build chamber and/or flow and distribution of thermal energy in the part cake. As used herein, the energy beam-powder interaction region includes a point where the energy beam intersects the build surface (e.g., the build surface 106 shown in FIG. 1) and can optionally include a melt pool (e.g., at least a portion of the melted powder) on the build surface. The physics-based models depend on the characteristics of the build chamber, operating conditions and the type of powder material used in the powder sintering process. Optionally, a controller (e.g., the controller described with regard to FIG. 7) can be used to compute the physics-based models. Optionally, in some scenarios, multiple controllers (e.g., multiple controllers described with regard to FIG. 7) can be used to compute the physics-based models in parallel (e.g., parallel processing). In some implementations, the theoretical or computational model can be used as feedback to provide real-time control the energy source (e.g., the energy source 112 shown in FIGS. 1 and 6), the heat sources (e.g., heat sources 110 shown in FIG. 2) and/or the inlet or outlet ports (e.g., inlet and outlet ports 114 shown in FIG. 3). In other implementations, the respective temperature distributions estimated from the images acquired by the multi-spectral imaging device 120A can be compared with the theoretical or computational model. In other words, the real-time operational characteristics measured during the powder sintering process can be compared with the predicted operational characteristics of the theoretical or computational model. Then, this information can be used as feedback to provide real-time control the energy source (e.g., the energy source 112 shown in FIGS. 1 and 6), the heat sources (e.g., heat sources 110 shown in FIG. 2) and/or the inlet or outlet ports (e.g., inlet and outlet ports 114 shown in FIG. 3). Similar as described above, this can provide the capability to adaptively control the thermal temperature time history with an increased level of detail, which can facilitate higher predictability and performance in the adaptive manufacturing process.

Alternatively or additionally, the apparatus 100 can optionally include a bore-sighted multi-spectral imaging device (e.g., the bore-sighted multi-spectral imaging device 120B shown in FIG. 6). The bore-sighted multi-spectral imaging device 120B can optionally be an IR imaging device. Although an IR imaging device is used in the example provided below, it should be understood that imaging devices that operate in other portions of the electromagnetic spectrum can be used. The bore-sighted multi-spectral imaging device 120B can be configured to acquire images of the energy beam-powder interaction region on the build surface, e.g., a point where the energy beam intersects the build surface (e.g., the build surface 106 shown in FIG. 1) and can optionally include a melt pool (e.g., at least a portion of the melted powder) on the build surface. In other words, the bore-sighted multi-spectral imaging device 120B can be configured to acquire images of the energy beam-powder interaction region as the energy beam scans across the build surface 106. For example, this can be achieved by aligning an acquisition axis of the bore-sighted multi-spectral imaging device 120B with an axis of the energy beam, which is shown in FIG. 6 where the bore-sighted multi-spectral imaging device 120B acquires images through a pass-through mirror 150. It should be understood that the images of the energy beam-powder acquisition region are reflected, for example, by the first and second mirrors 112B, 112C (which also incrementally steer the energy beam) and pass through the pass-through mirror 150 (which reflects the energy beam having a certain wavelength/frequency) for acquisition by the bore-sighted multi-spectral imaging device 120B as the energy beam scans across the build surface 106.

Similar as described above, using a controller (e.g., the controller described below with regard to FIG. 7), it is possible to estimate real-time properties of the energy beam-powder interaction region from the images acquired by the bore-sighted multi-spectral imaging device 120B. In addition, physics-based models can be computed to provide a theoretical or computational model(s) of the energy beam-powder interaction region for an energy beam-powder interaction region for a similar powder material under similar build chamber conditions as described above. Then, using the controller, the estimated real-time properties of the energy beam-powder interaction region acquired by the bore-sighted multi-spectral imaging device 120B can be compared with the theoretical or computational model. Then, this information can be used as feedback to provide real-time control the energy source (e.g., the energy source 112 shown in FIGS. 1 and 6), the heat sources (e.g., heat sources 110 shown in FIG. 2) and/or the inlet or outlet ports (e.g., inlet and outlet ports 114 shown in FIG. 3). The theoretical or computational models (and the comparison) can be used to identify potential flaws in the buildup process and/or make adjustments to the energy source and/or the overall thermal control system (e.g., the build chamber environment including heat sources and/or inlet or outlet ports) to maximize part property predictability and performance. This information can also enable a three-dimensional record of process/part quality for certification purposes.

Alternatively or additionally, the apparatus 100 can optionally include a non-optical imaging device configured to acquire images of the powder and the part. For example, the non-optical imaging device can be an acoustic or electro-magnetic imaging device. The non-optical imaging device can be arranged outside of the build chamber and can acquire images through the walls of the build chamber, for example. The non-optical imaging device can be used to acquire three-dimensional images of the part, the powder and/or the part cake, which can be used to identify/characterize the three-dimensional properties of the part within the part cake during the powder sintering process. These images can be used to identify/characterize conditions (e.g., defects, non-uniformities, etc.) of the part during the powder sintering process. Similar to above, this information can be used as feedback to provide real-time control the energy source (e.g., the energy source 112 shown in FIGS. 1 and 6), the heat sources (e.g., heat sources 110 shown in FIG. 2) and/or the inlet or outlet ports (e.g., inlet and outlet ports 114 shown in FIG. 3). Accordingly, this information can enable the ability to make adjustments to the energy source and/or the overall thermal control system (e.g., the build chamber environment including heat sources and/or inlet or outlet ports) to potentially mitigate properties created in earlier parts of the build process.

As described above, the real-time process controls described herein can minimize pre-mature additive manufacturing part failure due to hidden flaws associated with poor process management, as well as can enable additive manufacturing processing at higher environmental conditions while maintaining real-time control to reduce the induction of internal stresses in the manufactured parts. For example, conventional additive manufacturing technologies do not provide adaptive control of the thermal temperature time history at the level of detail enabled by the process controls described herein, which enable higher predictability and performance in resulting manufactured parts.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

When the logical operations described herein are implemented in software, the process may execute on any type of computing architecture or platform. For example, referring to FIG. 7, an example computing device (e.g., a controller) upon which embodiments of the invention may be implemented is illustrated. The computing device 700 may include a bus or other communication mechanism for communicating information among various components of the computing device 700. In its most basic configuration, computing device 700 typically includes at least one processing unit 706 and system memory 704. Depending on the exact configuration and type of computing device, system memory 704 may be volatile (such as random access memory (RAM)), non-volatile (such as read-only memory (ROM), flash memory, etc.), or some combination of the two. This most basic configuration is illustrated in FIG. 7 by dashed line 702. The processing unit 706 may be a standard programmable processor that performs arithmetic and logic operations necessary for operation of the computing device 700.

Computing device 700 may have additional features/functionality. For example, computing device 700 may include additional storage such as removable storage 708 and non-removable storage 710 including, but not limited to, magnetic or optical disks or tapes. Computing device 700 may also contain network connection(s) 716 that allow the device to communicate with other devices. Computing device 700 may also have input device(s) 714 such as a keyboard, mouse, touch screen, etc. Output device(s) 712 such as a display, speakers, printer, etc. may also be included. The additional devices may be connected to the bus in order to facilitate communication of data among the components of the computing device 700. All these devices are well known in the art and need not be discussed at length here.

The processing unit 706 may be configured to execute program code encoded in tangible, computer-readable media. Computer-readable media refers to any media that is capable of providing data that causes the computing device 700 (i.e., a machine) to operate in a particular fashion. Various computer-readable media may be utilized to provide instructions to the processing unit 706 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 706 may execute program code stored in the system memory 704. For example, the bus may carry data to the system memory 704, from which the processing unit 706 receives and executes instructions. The data received by the system memory 704 may optionally be stored on the removable storage 708 or the non-removable storage 710 before or after execution by the processing unit 706.

Computing device 700 typically includes a variety of computer-readable media. Computer-readable media can be any available media that can be accessed by device 700 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus for producing a part from a powder using a powder sintering process, comprising:
a build chamber including one or more walls, wherein the build chamber encloses a build cylinder and a build surface;
a build piston configured to support the powder and the part, wherein the build piston is arranged at least partially within the build cylinder;
a plurality of heat sources distributed in at least one of the walls of the build chamber, the build cylinder and the build piston;
an energy source configured to produce and direct an energy beam to the build surface, wherein the energy source is arranged outside of the build chamber; and
a controller configured to control the heat sources.

2. (canceled)

3. (canceled)

4. The apparatus of claim 1, wherein at least one of the build cylinder and the build piston further comprises one or more inlet or outlet ports formed therein for accommodating a flow of build chamber gases.

5. (canceled)

6. (canceled)

7. (canceled)

8. The apparatus of claim 4, further comprising a multi-spectral imaging device configured to acquire images of at least two of the build surface, the powder, the part, the walls of the build chamber and the build cylinder, wherein the controller is further configured to:
receive the images acquired by the multi-spectral imaging device;
estimate respective temperature distributions of the at least two of the build surface, the powder, the part, the walls of the build chamber and the build cylinder from the images acquired by the multi-spectral imaging device; and
control at least one of the energy source, the heat sources and the inlet or outlet ports based on the estimated respective temperature distributions.

9. The apparatus of claim 8, wherein the controller is further configured to:
calculate one or more theoretical or computational models for respective temperature distributions for the at least two of the build surface, the build chamber, the part and the powder under similar build chamber conditions;
compare the estimated respective temperature distributions with the theoretical or computational models; and
control at least one of the energy source, the heat sources and the inlet or outlet ports based on the comparison.

10. The apparatus of claim 8, wherein the multi-spectral imaging device is an infrared imaging device.

11. The apparatus of claim 4, further comprising a non-optical imaging device configured to acquire images of the powder and the part, wherein the controller is further configured to:
receive the images acquired by the non-optical imaging device;
determine a condition of the part from the images acquired by the non-optical imaging device; and
control at least one of the energy source, the heat sources and the inlet or outlet ports based on the condition of the part.

12. The apparatus of claim 11, wherein the non-optical imaging device is an acoustic or electro-magnetic imaging device.

13. The apparatus of claim 4, further comprising a bore-sighted multi-spectral imaging device configured to acquire images of an energy beam-powder interaction region on the build surface, wherein the controller is further configured to:
receive the images acquired by the bore-sighted multi-spectral imaging device;
estimate real-time properties of the energy beam-powder interaction region from the images acquired by the bore-sighted multi-spectral imaging device;
calculate one or more theoretical or computational models for an energy beam-powder interaction region for a similar powder material under similar build chamber conditions;
compare the estimated real-time properties of the energy beam-powder interaction region with the theoretical or computational models; and
control at least one of the energy source, the heat sources and the inlet or outlet ports based on the comparison.

14. The apparatus of claim 1, further comprising an energy beam power meter configured to measure a power of the energy beam, wherein the energy beam power meter is arranged near the build surface within the build chamber, and wherein the controller is further configured to:
receive the power of the energy beam; and
control the energy source based on the power of the energy beam measured within the build chamber.

15. The apparatus of claim 1, further comprising a powder feed device arranged outside of the build chamber, wherein the powder feed device includes:
a powder feed bin configured to store the powder;
a powder metering device configured to dispense a measured amount of the powder from the powder feed bin; and
a powder drop chute configured to guide the measured amount of the powder into the build chamber, wherein the powder metering device is arranged between the powder feed bin and the powder drop chute.

16. (canceled)

17. (canceled)

18. (canceled)

19. The apparatus of claim 1, further comprising a powder spreading device including:
a powder spreading roller arranged within the build chamber;
a drive system configured to control at least one of translation and rotation of the powder spreading roller; and
a thermal box including one or more thermal seals between the build chamber and components of the drive system, wherein the drive system and the thermal box are arranged outside of the build chamber.

20. (canceled)

21. (canceled)

22. A method for real-time control of a powder sintering process for producing a part from a powder, comprising:
providing a build chamber that encloses a build surface;
acquiring, using a multi-spectral imaging device, images of at least two of the build surface, the build chamber, the part and the powder;
estimating, using a controller, respective temperature distributions of the at least two of the build surface, the build chamber, the part and the powder from the images acquired by the multi-spectral imaging device; and
controlling, using the controller, the powder sintering process based on the estimated respective temperature distributions.

23. The method of claim 22, further comprising:
calculating, using the controller, one or more theoretical or computational models for respective temperature distributions for the at least two of the build surface, the build chamber, the part and the powder under similar build chamber conditions;
comparing, using the controller, the estimated respective temperature distributions with the theoretical or computational models; and
controlling, using the controller, at least one of the energy source, the heat sources and the inlet or outlet ports based on the comparison.

24. The method of claim 22, further comprising:
acquiring, using a non-optical imaging device, images of the part and the powder;
determining, using the controller, a condition of the part from the images acquired by the non-optical imaging device; and
controlling, using the controller, the powder sintering process based on the condition of the part.

25. The method of claim 22, further comprising providing an energy source configured to produce and direct an energy beam to the build surface, wherein controlling the powder sintering process further comprises adjusting characteristics of the energy beam.

26. The method of claim 25, further comprising:
acquiring, using a bore-sighted multi-spectral imaging device, images of an energy beam-powder interaction region on the build surface;
estimating, using the controller, real-time properties of the energy beam-powder interaction region from the images acquired by the bore-sighted multi-spectral imaging device;
calculating, using the controller, one or more theoretical or computational models for an energy beam-powder interaction region for a similar powder material under similar build chamber conditions;
comparing, using the controller, the estimated real-time properties of the energy beam-powder interaction region with the theoretical or computational models; and
controlling, using the controller, the powder sintering process based on the comparison.

27. The method of claim 22, wherein the build chamber includes a plurality of heat sources distributed therein, and wherein controlling the powder sintering process further comprises energizing or de-energizing one or more of the heat sources.

28. (canceled)

29. The method of claim 22, wherein:
the build chamber further encloses a build cylinder having a build piston arranged at least partially therein,
the build piston is configured to support the powder and the part,
at least one of the build cylinder and the build piston comprises one or more inlet or outlet ports formed therein, and
controlling the powder sintering process further comprises controlling operation of the inlet or outlet ports to adjust at least one of a temperature or a chemical composition of build chamber gases.

30. (canceled)

31. (canceled)

32. The method of claim 22, further comprising:
providing a powder feed bin configured to store powder, wherein the powder feed bin is arranged outside of the build chamber; and
dispensing a measured amount of the powder from the powder feed bin into the build chamber, wherein the measured amount of the powder undergoes rapid heat transfer as the powder enters the build chamber between an approximate temperature of the powder feed bin and a temperature that minimizes thermal mismatch and part curl when the powder is spread over the build surface.

33. (canceled)

34. A method for real-time control of a powder sintering process for producing a part from a powder, comprising:
providing a build chamber that encloses a build surface;
acquiring, using a multi-spectral imaging device, images of the build surface, the build chamber, the part or the powder;
estimating, using a controller, respective real-time temperature distributions of the build surface, the build chamber, the part or the powder from the images acquired by the multi-spectral imaging device;
calculating, using the controller, a real-time physics-based model of the powder sintering process based on the respective real-time temperature distributions; and
controlling, using the controller, the estimated powder sintering process based on the real-time physics-based model.
